(19) United States
(12) Patent Application Publication
(10) Pub. No.: US 2014/0190291 A1
(43) Pub. Date: Jul. 10, 2014

(54) FLIGHT-CONTROL ACTUATORS HAVING A SECONDARY NUT

(71) Applicant: Raphael Medina, Ecouen (FR)

(72) Inventor: Raphael Medina, Ecouen (FR)

(73) Assignee: Goodrich Actuation Systems SAS, Buck (FR)

(21) Appl. No.: 13/980,782

(22) PCT Filed: Jan. 19, 2012
(86) PCT No.: PCT/EP2012/050817

§ 371 Date: Oct. 30, 2013

(30) Foreign Application Priority Data
Jan. 19, 2011 (FR) 1150423

(51) Int. Cl. F16H 25/22

(52) U.S. Cl. CPC F16H 25/22
USPC 74/89.23

(57) ABSTRACT

The invention relates to a flight-control actuator comprising a control screw (1) that engages with a primary nut (2), the actuator also comprising a secondary nut (5) that engages with the control screw in the event the primary nut fails. The primary nut and the secondary nut are remote from one another, the secondary nut moving substantially along a portion of the screw that is usually not fitted with the primary nut.

The present invention relates to a flight-control actuator.

More particularly, it relates to horizontal flight-control actuators (THSA or Trimmable Horizontal Stabilizer Actuator, to use the English name).

Typically, as shown in FIG. 1, a flight-control actuator of this kind comprises a control screw 1 and a nut 2.

The screw 1 is attached by a universal joint system 3 to the structure S of the aircraft, whereas the nut 2, which cooperates with the screw 1 and is, for example, a ball circulating nut 2a, is mounted thereon while being connected to the plane P that is to be controlled, for example by means of another universal joint system 4.

It is conventional in aeronautics to duplicate the various means used in order to provide a redundancy. In this way, the failure of a single part cannot cause loss of monitoring of the control of the aircraft.

Thus, it is usual for the screw 1 to take the form of a hollow screw inside which extends a safety bolt 6 which provides a secondary pathway and takes over from the primary pathway formed by the hollow screw 1 should the latter fail.

It is also for this same reason that, in addition to the primary nut 2, a secondary nut 5 is provided which, in normal operation, does not engage with the screw thread of the screw 1 but takes over from the nut 2 in the event of failure of the latter. This secondary nut 5 may be for example a friction nut which is formed in one piece with the primary nut 2 and which is arranged so that its teeth do not engage with the thread of the control screw 1 as long as the primary nut 2 and its balls 2a are engaging on the screw 1. If, however, the balls 2a of the primary nut 2 were to come out of their housing, the secondary nut 5 would take over and absorb the force in place of the primary nut 2, thus maintaining control of the plane P.

What is envisaged here is a case where the failure is not due to breakage of the control screw 1 or the primary nut 2 but to the fact that the threads of the screw 1 are stripped, thus preventing any control of the apparatus.

Even though this type of incident appears to be hypothetical, it is possible to imagine that the force on the screw could generate the start of a fracture, or a crack could form on the screw thread of the control screw 1 and be propagated along the entire length of the screw under the primary nut 2. When a screw thread gives way and is disengaged from this primary nut 2, the latter is shifted and creates loading on the thread of the screw 1 underneath. The thread unwinds and is torn off the loaded length of the screw.

### GENERAL DESCRIPTION OF THE INVENTION

The aim of the invention is to propose a solution by which this problem could be solved.

More particularly, it proposes a flight-control actuator comprising a control screw that engages with a primary nut, the actuator also comprising a secondary nut that engages with the control screw in the event of failure of the primary nut, characterised in that the primary nut and the secondary nut are remote from one another and move essentially along two distinct zones of the screw.

In particular, the secondary nut moves substantially along a portion of the screw that is usually not fitted with the primary nut.

In this way, if a crack propagates along a thread of the screw or if a thread is subject to serious wear, the secondary nut takes over from the primary nut, cooperating with the thread on the screw at a zone thereof which is not normally subjected to stress and where, as a result, the crack will not propagate.

In this way, the stripping of the thread over the screw as a whole is prevented.

### DESCRIPTION OF THE DRAWINGS

Other features and advantages of the invention will become apparent from the following description which is purely illustrative and non-restrictive and should be read in conjunction with the attached drawings, wherein:

FIG. 1 schematically shows a flight-control actuator with a screw and nut according to a known embodiment of the prior art;

FIG. 2 shows one possible embodiment of the invention;

FIG. 3 shows another possible embodiment of the invention;

FIG. 4 shows yet another possible embodiment of the invention.

### DESCRIPTION OF ONE OR MORE EMBODIMENTS

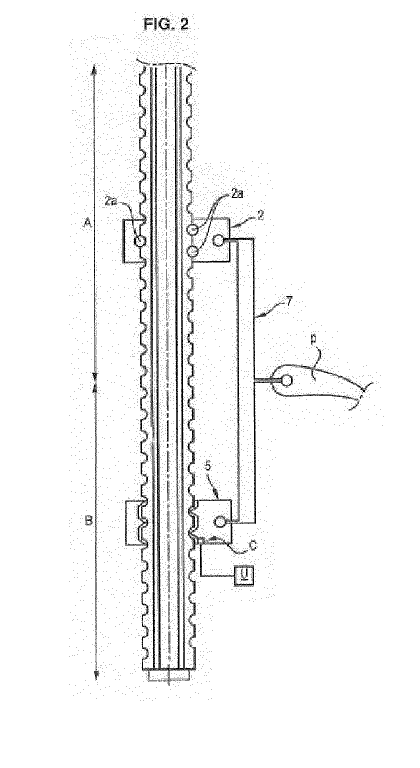

FIG. 2 shows the control screw 1 and the primary nut 2 of a flight-control actuator which is for example a horizontal flight-control actuator of the THSA type.

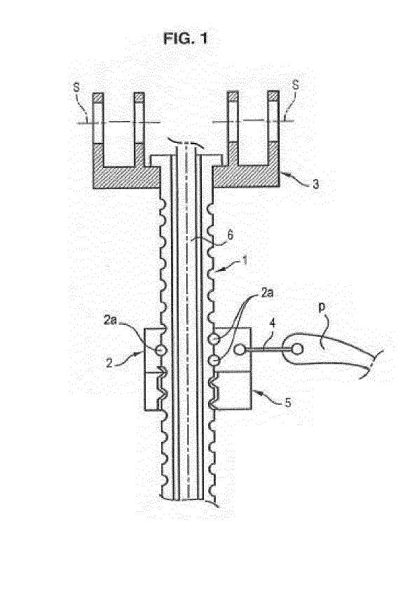

As in the case of the actuator in FIG. 1, this screw 1 is connected by a universal joint system (not shown in this FIG. 2) to the structure of the aircraft. The primary nut 2 is for example a ball circulating nut 2a. Its movement along the screw 1 controls the orientation of a control plane P.

The actuator also comprises, on the control screw 1, a secondary nut 5 which, in normal operation of the primary nut 2, does not engage with the thread of this screw 1 but cooperates with said screw 1 when the primary nut 2 fails.

The primary nut 2 is a ball circulating nut in the embodiment shown, while the secondary nut 5 is a friction nut.

In contrast to the case shown in FIG. 1, this nut 5 is remote from the primary nut 2, in this instance by several thread turns.

More precisely, this secondary nut 5 moves along a portion B of the screw 1 which is not usually fitted with the primary nut 2, the primary nut 2 essentially moving along a part A of the screw 1 that is separate from the part A.

When a crack or wear in the screw thread starts underneath the primary nut 2, the thread under the loaded zone disappears under the primary nut 2. When this thread is so worn that the primary nut is set to load the screw thread from below, the load is immediately taken up by the secondary nut in the zone B of the screw 1. In fact, this zone B is a crack-free and unworn zone because it is not generally subjected to loading. Thus, if a thread of the zone of the screw 1 normally subjected to stress were to prove defective, the load would be taken up by another zone of the screw 1 (zone B) which, itself, is not normally loaded and on which, as a result, the crack has had no reason to propagate.

The control is thus maintained even if there is the start of a failure of the thread of the screw 1.

In the embodiment shown in FIG. 2, this secondary nut 5 is connected, with the primary nut 2, via the same attachment flange 7 to the plane P, the orientation of which is being controlled.

Alternatively, the two nuts 2 and 5 may be fixed by independent attachment means to the plane P.

The zone A is defined for example as the zone in which the primary nut 2 moves for 90% of the flight times.

Zone B is for example a zone of the screw 1 which is only acted upon by this same primary nut for less than 50% of the flight times, for example less than 20%, preferably less than 10%.

For example, but without being restricted thereto, the screw 1 may have a total length of the order of 650 mm. For 90% of the flight time the primary nut acts only on a zone limited to a length of about 150 mm while the other 500 mm are subjected to little stress. The secondary nut 5 is located opposite this second zone.

As already mentioned, if the thread of the screw 1 were to become worn in the zone A which is the zone acted upon by the nut 2, the secondary nut 5 would re-engage with the part of the screw thread opposite which it is located (zone B) and would do so before the thread in zone A gave way. This zone B of the screw 1 and the secondary nut 5 thus take over from the failing screw thread in zone A and the primary nut 2.

A force sensor C which makes it possible to detect the loading of the secondary nut 5 is provided on a level with the latter. This sensor is connected for example to an electronic unit U which carries out processing of the sensors to which it is connected and sends the data to a computer on the aircraft, for example so as to trigger an alarm indicating that a maintenance operation has to be carried out when the aircraft next lands.

In one embodiment, the primary nut 2 and the secondary nut 5 are remote and move essentially along two distinct zones of the screw 1 (zones A and B), and the two distinct zones of the screw 1 are separated by a blocking system 8 configured to prevent a fracture appearing in one of said zones of the screw from propagating towards the other one of said zones.

This blocking system 8 may be formed in various ways.

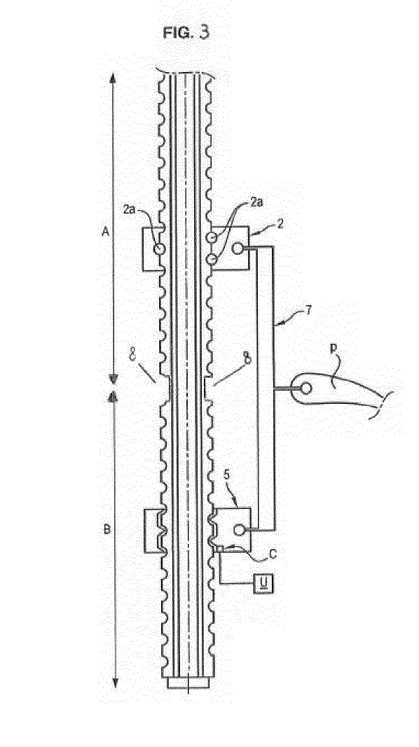

FIG. 3 shows a case in which the blocking system 8 is a discontinuity introduced into the thread of the screw 1, between the two usual displacement zones A and B of the primary nut 2 and secondary nut 5. As will be understood, if the thread of the screw 1 were to become worn or break in the zone A, which is the zone acted upon by the primary nut 2, this break could not propagate towards the zone B, which is the zone acted upon by the secondary nut 5, and vice versa, owing to the presence of the discontinuity 8.

The blocking system 8 may also be a groove or any other structure that prevents the fracture from propagating from one zone to the other.

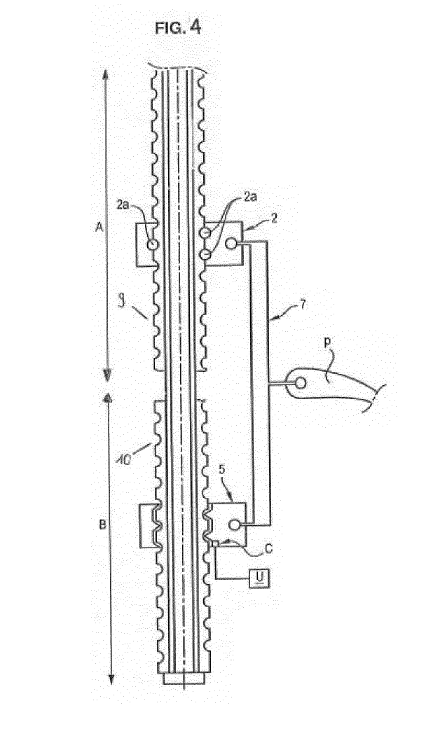

In another embodiment, shown in FIG. 4, the control screw 1 consists of a first control screw 9 which cooperates with the primary nut 2, and a second control screw 10 which is distinct from the first control screw 9 and cooperates with the secondary nut 5.

In this case, the primary nut 2 moves along the first screw 9, and the secondary nut moves along the second screw 10.

Given that two distinct screws 9, 10 are used, the primary nut 2 cannot move along the second screw 10, and the secondary nut 5 cannot move along the first screw 9.

The first screw 9 and the second screw 10 are connected for example by a channel (not shown).

Moreover, a fracture appearing at the zone of the first screw 9 could not propagate towards the zone of the second screw 10, given that they are two distinct screws.

For example, if a first threaded control screw 9 and a second threaded control screw 10 are used, a fracture in the thread of the first screw 9 cannot propagate towards the thread of the second screw 10.

Thus, in these embodiments, the zone along which the secondary nut 5 travels is protected from the propagation of a fracture appearing in the zone along which the primary nut 2 travels.

The control screw 1 is a threaded screw, for example. However, the invention also applies to different types of control screws and is not limited to a threaded screw. Thus, the control screw 1 may be for example a ball screw or a roller screw or a plain screw. Other types of screw may be used, whether the control screw has a single section, or is made up of two sections (first and second control screws).

Similarly, the nuts 2, 5 used in conjunction with the control screw 1 may be based on various technologies: ball circulating nuts, friction nuts, etc.

1. Flight-control actuator comprising a control screw that engages with a primary nut, the actuator also comprising a secondary nut that engages with the control screw in the event of failure of the primary nut, characterised in that the primary nut and the secondary nut are remote from one another and move essentially along two distinct zones of the screw.

2. Flight-control actuator according to claim 1, characterised in that the secondary nut moves essentially along a portion of the screw that is not habitually engaged by the primary nut.

3. Flight-control actuator according to claim 1, characterised in that the primary nut and the secondary nut are connected to the plane that is to be controlled by means of a single attachment flange.

4. Flight-control actuator according to claim 1, characterised in that the primary nut and the secondary nut are connected to the plane that is to be controlled by means of distinct attachment means.

5. Flight-control actuator according to claim 1, characterised in that the primary nut is embodied here as a ball circulating nut, while the secondary nut is a friction nut.

6. Flight-control actuator according to one of claims 1 to 5, characterised in that:
the primary nut and the secondary nut are remote from one another and move essentially along two distinct zones of the screw, and
the two distinct zones of the screw are separated by a blocking system, configured to prevent a fracture appearing at one of said zones of the screw from propagating towards the other of said zones.

7. Flight-control actuator according to claim 6, wherein the blocking system is a groove or a discontinuity in the control screw.

8. Flight-control actuator according to one of claims 1 to 5, characterised in that the control screw is made up of:
a first control screw which cooperates with the primary nut, and
a second control screw which is distinct from the first control screw and which cooperates with the secondary nut,
the primary nut moving along the first screw, and the secondary nut moving along the second screw.

9. Flight-control actuator according to one of claims 1 to 8, characterised in that the control screw is selected from among a threaded screw, a ball screw or a roller screw.

10. Horizontal flight-control actuator, characterised in that it comprises an actuator according to any one of the preceding claims.
